(19) United States
(12) Patent Application Publication
(10) Pub. No.: US 2014/0306791 A1
(43) Pub. Date: Oct. 16, 2014

(54) POWER CONVERTER

(71) Applicant: Hitachi Automotive Systems, Ltd., Hitachinaka-shi (JP)

(72) Inventors: Takuro KANAZAWA, Tokyo (JP); Kinya NAKATSU, Tokyo (JP); Haruaki MOTODA, Hitachinaka (JP)

(73) Assignee: HITACHI AUTOMOTIVE SYSTEMS, LTD., HITACHINAKA-SHI (JP)

(21) Appl. No.: 14/249,839

(22) Filed: Apr. 10, 2014

(30) Foreign Application Priority Data
Apr. 11, 2013 (JP) 2013-082640

(51) Int. Cl. H01F 27/06; H01F 27/34

(52) U.S. Cl. CPC H01F 27/06; H01F 27/34
USPC 336/199

(57) ABSTRACT

An inverter is offered which has a substrate having a capacitor, a semiconductor device, and so on mounted thereon, a metal enclosure securely holding the substrate, and a choke coil of an open magnetic path structure. The choke coil has a rod-like core disposed perpendicularly to the substrate. The choke coil is electrically connected with the substrate via coil terminals on a coil element. At least one cutout is formed in a surface of the substrate which is located opposite to one axial end (lower end) of the rod-like core of the choke coil.

### BACKGROUND OF THE INVENTION

The present invention relates to an inverter for converting DC power into AC power and also to a power converter for converting input and output voltages. More particularly, the invention relates to a power converter having a substrate on which filter parts (such as a capacitor and a choke coil) and a semiconductor device are all mounted, the choke coil having an open magnetic path.

For example, JP-A-2000-14149 and JP-A-2012-84717 exist as background techniques for the present technical field. JP-A-2000-14149 states that a base plate which supports the wiring substrate of an inverter circuit has a parallel plate portion extending parallel to the wiring substrate and that an electrical transformer or a choke coil has its bottom surface in intimate contact with the principal surface of the parallel plate portion on the wiring substrate side, the transformer or choke coil protruding toward the mounting surface of the wiring substrate from a hole or a cutout formed in the wiring substrate.

JP-A-2012-84717 states that a rectifier circuit substrate has an electrical transformer and a choke coil which are secured by core holders mounted to an enclosure as as diodes on a printed wiring sheet, and forms a laminated circuit board of laminated layers of substrate formed by resinous plates bonded to the printed wiring sheet.

The techniques of JP-A-2000-14149 and JP-A-2012-84717 described so far pertain to transformers or choke coils formed by closed magnetic paths. A choke coil formed by an open magnetic path is disclosed in JP-A-11-186490. JP-A-11-186490 states that there is provided a substrate on which a plastic molded IC package and capacitors are mounted and that there are leg portions on both sides of a winding portion forming a coil. Furthermore, it states that the leg portions are mounted over the capacitors and the plastic molded IC package in a three-dimensional manner and that the whole top surface of the substrate on which various electronic parts are mounted is sealed with a resinous encapsulant, the surface of the encapsulant having a plating layer of nickel thereon.

### SUMMARY OF THE INVENTION

However, there is the problem that the conventional choke coil formed by a closed magnetic path is larger in size than other components to thereby increase the required space, thus making it difficult to miniaturize the inverter. Furthermore, additional parts are required to hold split core sections. This may increase the number of components and the number of processing steps. Moreover, in order to achieve a structure free of flux leakage, a complex core shape is adopted and a large amount of magnetic material is used. This may increase the cost to fabricate the inverter. As described so far, where the choke coil formed by a closed magnetic path is mounted on a substrate, it has been difficult to fabricate an inverter compactly and economically.

On the other hand, a choke coil formed by an open magnetic path has the advantage that the core has a simple shape and is made of a small amount of material. However, when a magnetic field produced by passage of electrical current through the coil crosses the leads in periphery circuitry, eddy currents are induced, causing a malfunction of the circuitry. Furthermore, when the magnetic field generated by passage of electrical current through the coil crosses the metal enclosure around the coil, eddy currents induced in the metal enclosure cancel the magnetic field. This produces the problem that the inductance value of the choke coil decreases. As described so far, where a choke coil formed by an open magnetic path is mounted on a substrate, any metal cannot be disposed around it and, therefore, it has been difficult to adopt this choke coil in a power converter such as an inverter.

The present invention is intended to solve the foregoing problems. It is an object of the present invention to provide a power converter in which eddy currents induced by electrical current flowing through a coil element are suppressed to thereby suppress the inductance value of a choke coil from decreasing.

In order to solve the foregoing problems, configurations, for example, set forth in the appended claims are adopted. The invention of the subject application embraces a plurality of means that solve the foregoing problems. One of them is a power converter having a first substrate on which electronic parts are mounted, a metal enclosure securely holding the substrate, and a choke coil of an open magnetic path structure. The choke coil has a cylindrical core disposed perpendicularly to the substrate. The choke coil is electrically connected with the substrate via current input-output portions of a coil element. At least one cutout is formed in a surface of the first substrate which is located opposite to one axial end of the cylindrical core of the choke coil.

According to the present invention, when the choke coil formed by the open magnetic path is mounted on the substrate, the inductance value of the choke coil is suppressed from decreasing by forming the cutout in the substrate. This allows for miniaturization and lower cost of the power converter.

Other configurations and advantages will become appear from the description of the embodiments provided below.

### BRIEF DESCRIPTION OF THE DRAWINGS

FIG. 1 is a side elevation, partly in cross section, of an inverter according to embodiment 1 of the present invention.

FIG. 2 is a plan view of the choke coil of the inverter shown in FIG. 1. FIGS. 3A-3D are explanatory views showing respective examples of the shapes of cutouts according to the present invention, the cutouts being located near the rod-like core of the choke coil.

FIG. 4 is a side elevation, partly it cross section, of an inverter according to embodiment 2 of the invention.

FIG. 5A is a plan view of a main portion of the inverter shown in FIG. 4

FIG. 5B is a plan view of the inverter and in which the choke coil has been.

FIGS. 6A-6C are explanatory views showing respective examples of the shapes of cutouts and holes according to the present invention, the cutouts and holes being located near the rod-like core of the choke coil.

FIG. 7 is a side elevation, partly in cross section, of an inverter according to embodiment 3 of the invention.

FIG. 8A is a plan view of a main portion of the inverter shown in FIG. 7,

FIG. 8B is a plan view of the inverter and in which the choke coil has been removed.

FIG. 9 is a side elevation, partly in cross section, of an inverter according to embodiment 4 of the invention.

FIG. 10 is a side elevation, partly in cross section, of an inverter according to embodiment 5 of the invention.

FIG. 11 is a side elevation, partly in cross section, of an inverter according to embodiment 6 of the invention.

FIG. 12 is a side elevation, partly in cross section, of an inverter according to embodiment 7 of the invention.

FIG. 13 is a side elevation, partly in cross section, of an inverter according to embodiment 8 of the invention.

FIG. 14 is a side elevation partly in cross section, of an inverter according to embodiment 9 of he invention.

### DETAILED DESCRIPTION OF THE EMBODIMENTS

The preferred embodiments of the present invention are hereinafter described with reference to the drawings to be noted that the present invention is not restricted thereto. Embodiments 1-9 provided below show embodiments in which the present invention is applied to inverters.

### Embodiment 1

FIG. 1 is a side elevation, partly in Toss section, of an inverter, generally indicated by reference numeral 1 first substrate 11 is a metal-based substrate including a metal base 18 on which a dielectric layer 12 and substrate wiring 13 are laminated. A choke coil 2 being a noise suppression part, a capacitor 16 for smoothing voltages, and a semiconductor device 17 for converting electric power are mounted on the substrate 11.

The choke coil 2 has a rod-like or cylindrical core 15, a coil element 4 wound around the core 15, and coil terminals 14a, 14b connected with the substrate wiring 13 on the substrate 11. These coil terminals 14a and 14b constitute current input-output portions of the choke coil. The choke coil is designed as an open magnetic path structure. The capacitor 16 and semiconductor device 17 are also soldered and connected to the substrate wiring 13 on the substrate 11.

Examples of the capacitor 16 include electrolytic capacitors, conductive polymer aluminum electrolytic capacitors, film capacitors, and ceramic capacitors. Examples of the semiconductor device 17 include MOSFETs and IGBTs. Next-generation semiconductor devices such as SiC and GaN may also be used.

The electronic parts mounted may be plural in number in an unillustrated manner. Furthermore, a mechanical relay for cutting off electrical current in an emergency, a common mode choke coil being a noise suppression part, a gate resistor, other chip parts, and a lead frame for connection with external circuitry may also be mounted. The rod-like core 15 of the choke coil 2 is preferably in the form of a round rod. Although the coil element 14 is shown as a rectangular wire, it may also be a round wire or a square wire. The coil terminals 14a and 14b of the coil element 14 connected with the substrate wiring 13 are shown to extend in the left-and-right direction. The coil terminals 14a and 14b may extend in any arbitrary direction within 360 degrees in accordance with the layout of the substrate wiring 13.

The metal base 18 is made of a material having a large thermal conductivity such as aluminum copper. The substrate wiring 13 are made of copper having a large thermal conductivity, The dielectric layer 12 is preferably made of an insulating material having a thermal conductivity of 2 W/m K or more and a thickness of 100 micrometers or less in order to efficiently dissipate away heat generated by the semiconductor device 17 The substrate 11 is mounted on a metal enclosure 10 for securing and heat dissipation Preferably, the metal enclosure 10 is made of aluminum that has a large specific heat and is lightweight. A heat dissipating member(got shown) such as grease may be interposed between the metal base 18 and the metal enclosure 10 to achieve good thermal contact between them. The substrate 11 is screw-clamped to the metal enclosure 10.

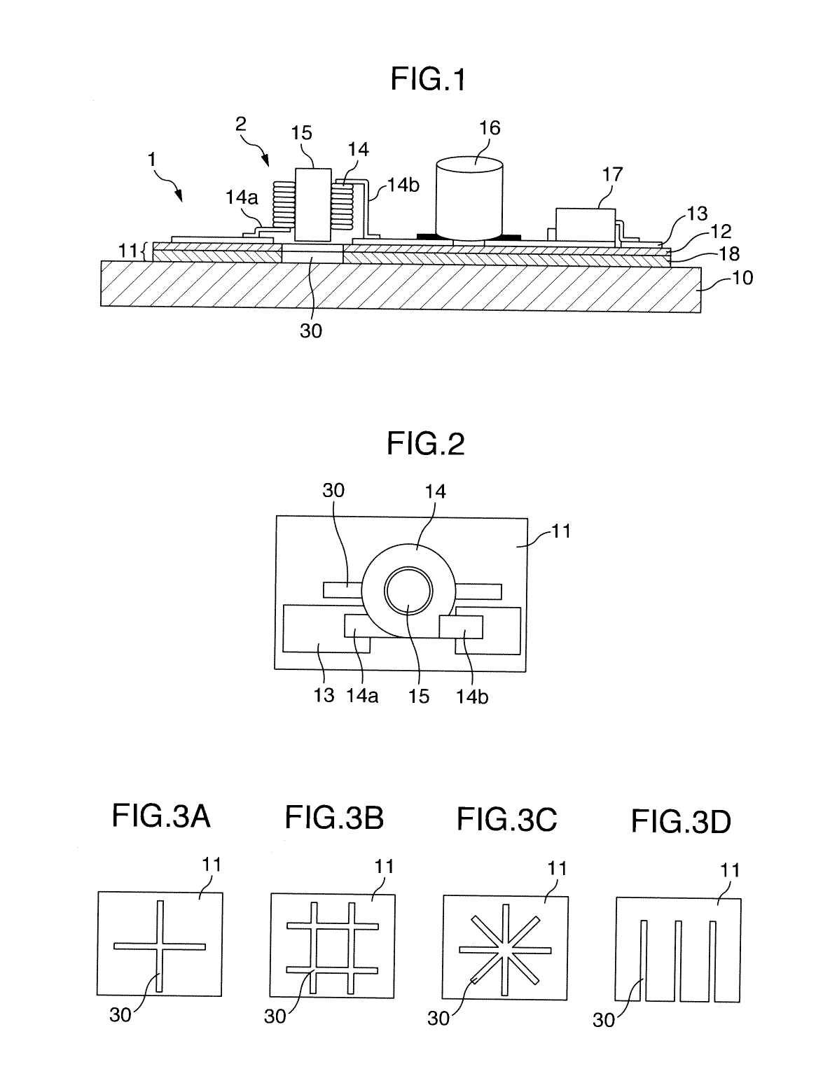

The manner in which each part is mounted is next described. The rod-like core 15 of the coil element 14 is disposed such that the axial direction of the core 15 is perpendicular to the substrate 11. A cutout 30 is formed in a portion of the substrate 11 located opposite to one axial lower end (lower end) of the rod-like core 15 by blanking, cutting off, or other work. FIG. 2 shows the choke coil of the substrate 11, as viewed from a side of the choke cod 2. The surface of the substrate 11 which is opposite to the rod-like core 15 is provided with the single straight cutout 30 extending laterally.

It is conceivable that the cutout 30 assumes shapes as shown in FIGS. 3A-3D. That is FIGS. 3A-3D show the plane through the portion of the substrate 11 in which the cutout 30 is formed. In FIG. 3A, the cutout 30 assumes a crisscross shape. In FIG. 3B, the cutout 30 consists of a combination of two vertical parallel lines and two horizontal parallel lines. In FIG. 3C, the cutout 30 consists of a combination of a crisscross and art X-shaped mark. In FIG. 3D, the cutout 30 consists of three parallel lines.

The number of the elements of the cutout 30 and its shape are so determined that the magnetic field (lines of magnetic force) produced when electrical current flows through the coil element 14 can block the eddy currents produced when penetrating the metal base 18

Preferably, the length of the cutout 30 is equal to or greater than the outside diameter of the coil element 14 because the leaking magnetic fluxes pass outside the coil element 14. It is assumed that the outside diameter of the coil element 14 of the choke coil 2 is 20 mm. If the spread of the magnetic field set up by the choke coil 2 is taken into consideration, the cutout 30 is 28 mm or more in length. Furthermore, the cutout 30 is preferably so deep that it extends through the metal base 18 to completely suppress generation of eddy currents. In FIG. 1, the bottom surface of the rod-like core 15 (i.e., the surface at one axial end) and the top surface of the substrate 11 are shown to be located at the same position. Alternatively, a gap may exist between the rod-like core 15 and the substrate 11.

Because of the structure described so far, when the magnetic field generated by passage of electrical current through the coil element 14 penerates the substrate 11, the cutout 30 suppresses generation of eddy currents. That is, the inductance value of the choke coil 2 is suppressed from decreasing. This makes it possible to surface-mount the choke cod 2 of open magnetic path structure onto the substrate 11.

Where the distance between the rod-like core 15 d the metal enclosure 10 is small, the effects of eddy currents can be suppressed by forming an additional cutout in the metal enclosure 10. If this additional cutout is located at the same position of the cutout 30 formed in the substrate 11 and the additional cutout in the enclosure 10 is so shaped as to block eddy currents as shown in FIGS. 3A-3D, then it is not necessary that the additional cutout in the enclosure 10 be identical in shape with the cutout 30 in the substrate 11.

As described in detail so far, the present embodiment 1 can yield the following advantageous effects.

(1) Generation of eddy currents due to electrical current flowing through the coli element 14 is suppressed. The inductance value of the choke coil 2 is suppressed from decreasing. Therefore, a choke coil formed by an open magnetic path rather than a closed magnetic path can be used as the choke coil 2 mounted on the substrate 11. As a result, a reduction in the cost of the inverter can be achieved.

(2) A state in which the rod-like core 15 is in contact with l e substrate 11 can be achieved. That is the surface at one axial end (lower end) of the core 15 can be made flush with the top surface of the substrate 11. Hence, a decrease in the heightwise dimension of the inverter can be achieved.

(3) The number of members used for wiring can be reduced by mounting the choke coil 2 and other parts on the same substrate. This achieves reductions in the size and cost of the inverter.

### Embodiment 2

In the description provided below, a description both of those configurations which are indicated by the same reference numerals as in FIG. 1 showing the inverter and of those portions identical in function with their counterparts of FIG. 1 is omitted.

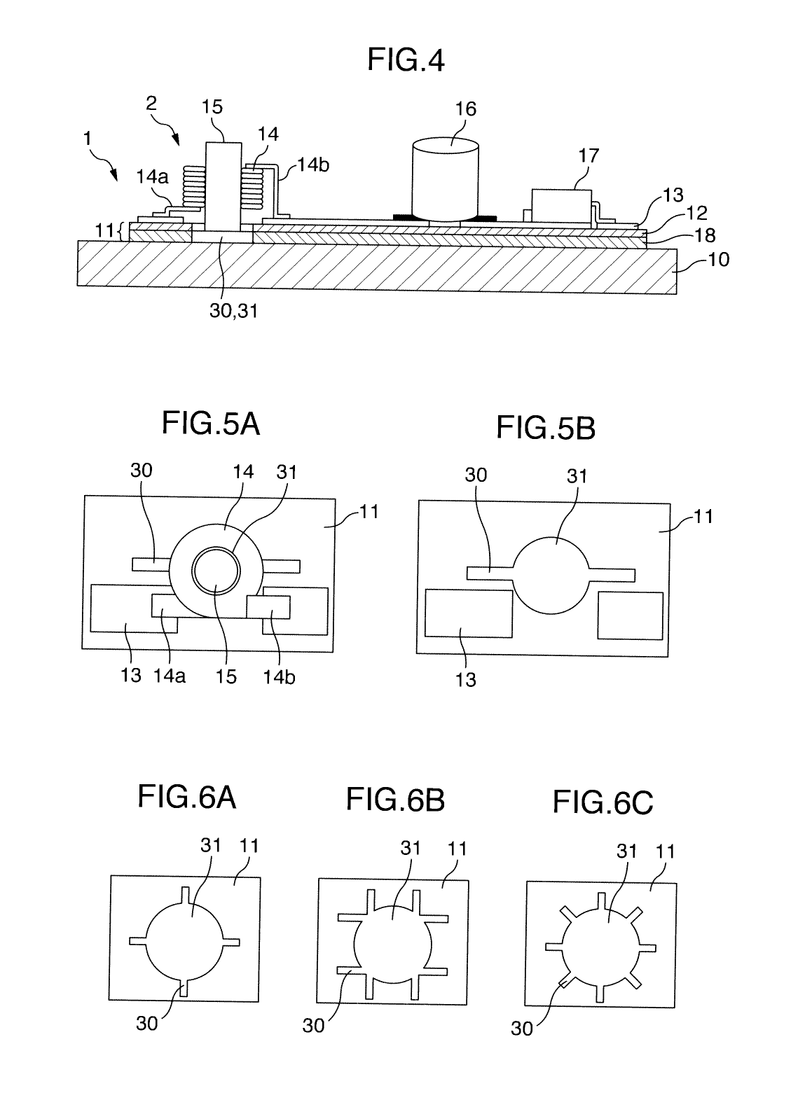

FIG. 4 is a side elevation, partly in cross section, of the inverter 1 according to embodiment 2. In FIG. 4, a cutout 30 and a hole 31 are formed by blanking, cutting off, or other work in a portion of the substrate 11 which is opposite to the surface at one axial end (lower end) of the rod-like core 15. The outside diameter of the hole 31 is set larger than the diameter of the rod-like core 15. The rod-like core 15 is so disposed that its one axial end is fitted in the hole 31 up to the top of the hole.

FIGS. 5A and 5B are views of the choke coil on the substrate 11, as viewed from a side of the choke coil 2. FIG. 5A shows a state in which there is the choke coil 2 FIG. 5B shows a state in which the choke coil 2 does not exist. Where only the hole 31 is formed, a magnetic field produced when electrical current flows through the coil element 14 induces eddy currents in the metal base 18, reducing the inductance value of the choke coil 2. Where the cutout 30 is formed along with the hole 31, generation of eddy currents is suppressed. This suppresses the inductance value from decreasing. Preferably, the length of the cutout 30 is equal to or greater than the outside dimension of the coil element 14 The depth of the cutout 30 is preferably so set that the cutout extends through the metal base 18. It is conceivable that the cutout 30 and hole 31 assume shapes as shown in FIGS. 6A-6C. The cutout 30 and hole are so shaped that the magnetic field produced when electrical current flows through the coil element 14 can block eddy currents induced when the magnetic field penetrates the metal base

In particular, FIGS. 6A-6C show the plane through the portion of the substrate in which the cutout 30 and hole 31 are formed. In FIG. 6A, a combination, of the cutout 30 in a crisscross form and the hole 31 in a circular form is used. In FIG. 6B, a combination of the cutout 30 in the form of double crosses and the hole 31 in a circuit form is used in FIG. 6C, a combination of the cutout 30 in a form consisting of a crisscross and an X-shaped mark and the hole 31 in a circular form is used.

It is to be understood that the shape of the hole 31 is not restricted to a circle. The shape may also be a polygon or ellipse as long as the hole is larger than the diameter of the rod-like core 15.

Where the rod-like core 15 and the metal enclosure 10 are close to each other, the effects of eddy currents can be suppressed by forming a cutout al so in the metal enclosure 10. If the cutout in the enclosure 10 is located at the same position of the cutout 30 formed in the substrate 11, and if the cutout in the enclosure 10 is so shaped that it blocks eddy currents as shown in any one of FIGS. 3A-3D, then it is not necessary that the cutout in the enclosure 10 be identical in shape with the cutout 30 in the substrate 11.

As described in detail thus far, according to the present embodiment 2, the lower end of the rod-like core 15 is fitted in the hole 31 formed in the substrate 11 and so the height at which the choke coil 2 is mounted can be made lower. Furthermore, the provision of the cutout 30 together with the hole makes it possible to reduce the size of the inverter without reducing the inductance value of the choke coil 2.

### Embodiment 3

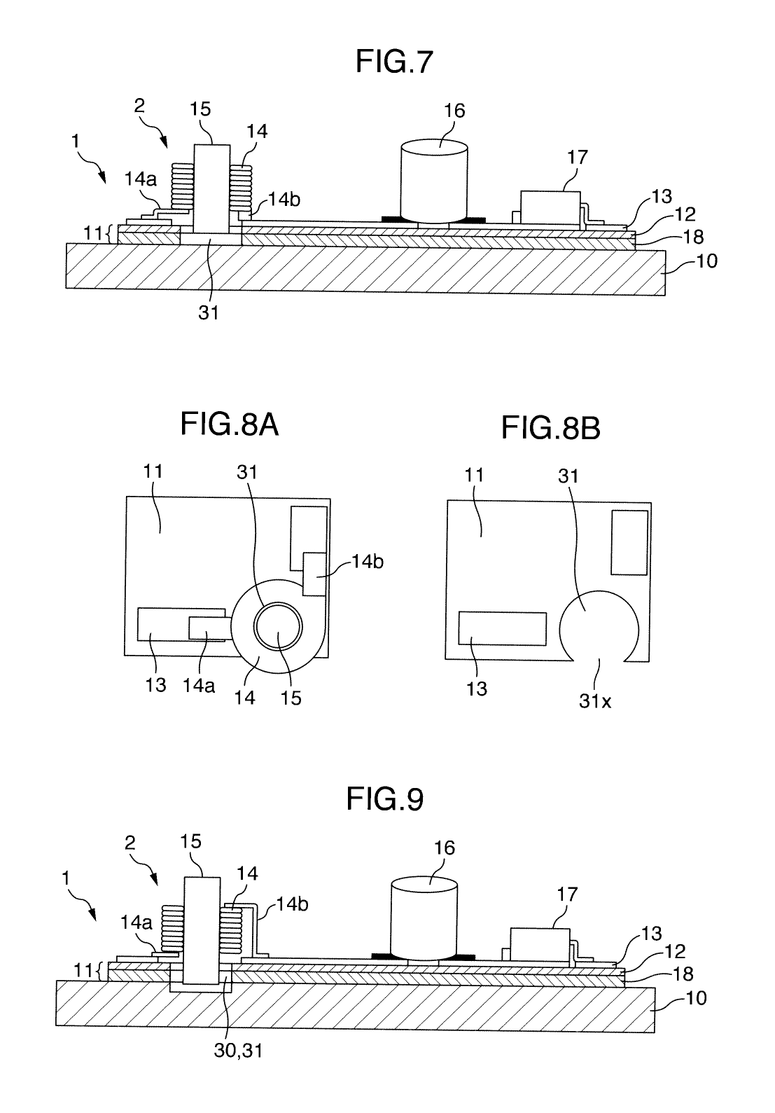

FIG. 7 is a side elevation, partly in cross section, of the inverter according to embodiment 3 of the present invention. In FIG. 7, those parts which are identical with their respective counterparts of FIGS. 1 and 4 are indicated by the same reference numerals as in FIGS. 1 and 4. In FIG. 7, a hole 31 is formed by blanking, cutting off, or other work in a portion of the substrate 11 which is opposite to the surface at one axial end (lower end) of the rod-like core 15. The outside diameter of the hole 31 is set larger than the diameter of the rod-like core 15. The rod-like core 15 is so disposed that its one axial end is fitted in the hole 31 up to the top of the hole 31.

The choke coil 2 (having the coil element 14 and rod-like core 15) and the hole 31 formed in this way are disposed so as to cross end portions of the substrate 11 as shown in FIGS. 8A and 8B which are plan views of the vicinities of the choke coil 2. That is, a part of the radial end of the coil element 14 sticks out of one side of the substrate 11 as shown in FIG. 8A rating the manner in which the choke coil 2 is disposed. The circular hole 31 formed in the substrate 11 has a cutout 31× at one side of the substrate 31 as shown in FIG. 8B which shows a state in which the choke cod 2 has been removed.

This cutout 31× of the hole operates to block eddy currents induced by the magnetic field produced by electrical current flowing through the coil element 44, in the same way as the cutout 30 described in embodiments 1 and 2.

Therefore, the cutout can be formed simultaneously with the hole 31. This results in improved productivity. Furthermore, the operation for forming the hole 31 is carried out in the step of cutting out the metal-based substrate 11 or in the step of forming threaded holes used to secure the substrate 11. Hence, the number of mechanical processing steps can be reduced.

Where rod-like core 15 and the metal enclosure 10 are close to each other, it possible to suppress the effects of eddy currents by forming a cutout or cutouts in the metal enclosure 10. In this case, the position of the cutout is the same as the hole 31 opposite to the rod-like core 15. The length of the cutout is greater than the outside diameter of the coil element 14 The cutout is so shaped that it blocks eddy currents as shown in any one of FIGS. 3A-3C.

As described so far, according to the present embodiment 3, the hole 31 formed in the substrate 11 located opposite to the choke coil 2 intersects end portions of the substrate 11. Therefore, simultaneously when the hole 31 is formed, the hole cutout 31× producing the same advantageous effects as obtained by a cutout is formed This reduces the number of mechanical processing steps, resulting in improved productivity.

### Embodiment 4

FIG. 9 is a side elevation, partly in cross section of the inverter 1 according to embodiment 4. In FIG. 9, those portions which are identical with their respective counterparts of FIGS. 1, 4 and 7 are indicated by the same reference numerals as in FIGS. 1, 4, and 7.

In FIG. 9, a cutout 30 and a hole 31 are formed by blanking, cutting off or other work in portions of the substrate 11 and metal enclosure 10 which are opposite to the surface at one axial end (lower end) of the rod-like core 15 The outside diameter of the hole 31 is set larger than the diameter of the rod-like core 15. The rod-like core 15 is so disposed that its one axial end is fitted in the hole 31 formed in the metal enclosure 10 up to the top of the hole 31.

The cutout 30 and hole 31 formed in the substrate 11 and metal enclosure 10 can assume shapes as shown in FIGS. 6A-6C and 8A, 8B They may be shaped at will as long as generated eddy currents are blocked, In particular, the hole 31 is greater in diameter than the rod-like core 15 Where the outside diameter of the coil element 14 of the choke c is 20 mm. the cutout 30 is 28 mm in length. Where the spread of the magnetic field produced by the choke coil 2 is taken into account, the depth of the cutout 30 formed in the metal enclosure 10 is 3 mm or more as measured from the surface of the rod-like core 15 opposite to the metal enclosure 10.

Because of the above-described structure, if the rod-tike core 15 has a large axial length, the inductance value can be prevented from decreasing. Furthermore, the height at which the choke coil 2 is mounted can be lowered. Consequently, a reduction in size of the inverter 1 can be accomplished.

Where the rod-like core 15 and the bottom surface of the hole 31 in the metal enclosure 10 are close to each other, the effects of eddy currents can be suppressed by forming an additional cutout in the bottom surface of the hole 3 of the metal enclosure 10. In this case, it is not necessary that the additional cutout be identical in shape with the cutout 30 in the substrate 11 if the additional cutout is located opposite to the rod-like core 15 and so shaped that eddy currents are blocked, for example, as shown in any one of FIGS. 3A-3D

As described so far, according to the present embodiment 4, the cutout 30 and hole 31 are also formed in the metal enclosure 10 located opposite to the rod-like core 15. In consequence, the inverter can be reduced in size without lowering the inductance value of the choke coil 2 by lowering the height at which the choke coil 2 is mounted.

### Embodiment 5

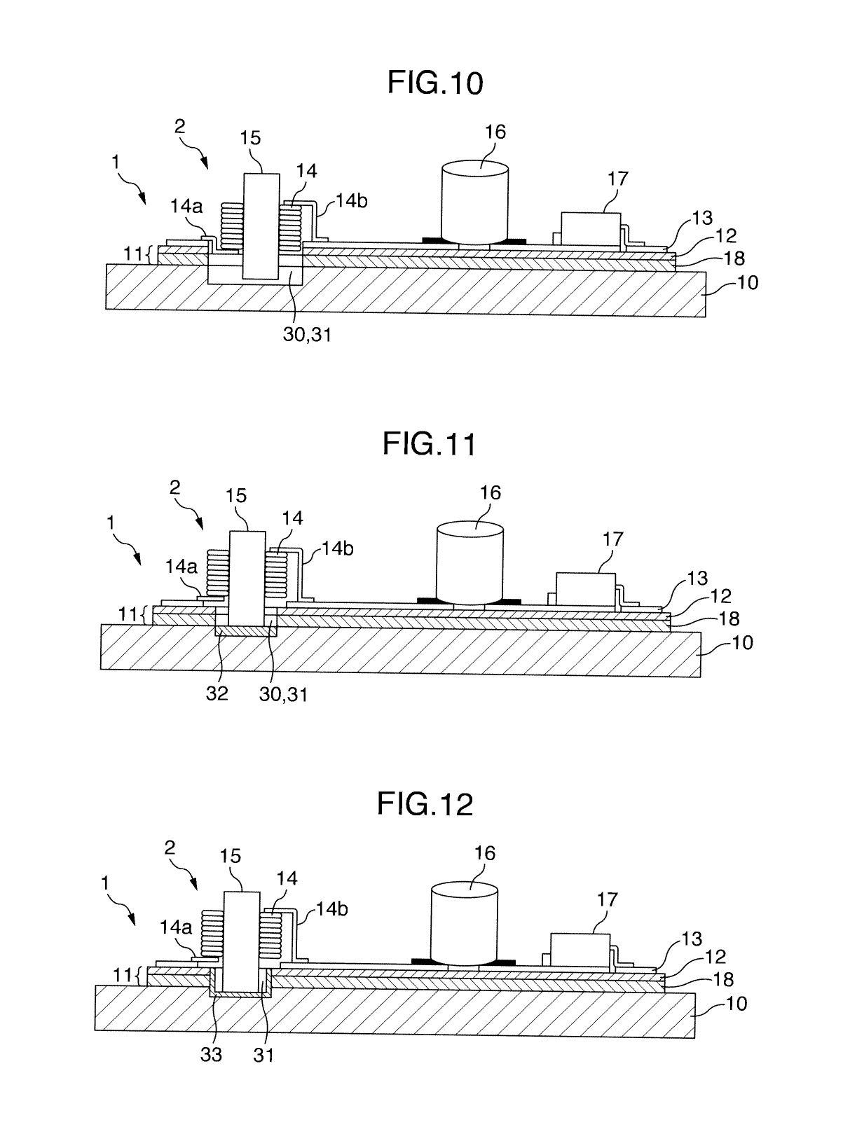

FIG. 10 is a side elevation, party in cross section, of the inverter 1 according to embodiment 5 of the present invention. In FIG. 10, those portions which are identical with their respective counterparts of FIGS. 1, 4, 7, and 9 are indicated by the same reference numerals as in FIGS. 1, 4, 7, and 9. A cutout 30 and a hole 31 are formed in portions of the substrate 11 and metal enclosure 10 which are located opposite to the choke coil 2, in the same way as in FIG. 9.

In the present embodiment 5 the outside diameter of the hole 31 is set larger than the outside diameter of the choke coil 2. The choke coil 2 is mounted in such a way that one axial end (lower end) of the rod-like core 15 and one axial end (lower end) of the coil element 14 are both fitted in the hole 31 The cutout 30 and hole 31 are shaped at will as shown in FIGS. 6A-6C and 8A-8B, as long as eddy currents are blocked.

Where the rod-like core 15 and the bottom surface of the hole 31 in the metal enclosure 10 are close to each other, the effects of eddy currents can be suppressed by arranging an additional cutout in the bottom surface of the hole 31 of the metal enclosure 10. In this structure, if the additional cutout is located opposite to the rod-like core 15 and so shaped that it blocks eddy currents as shown in any one of FIGS. 3A-3D, then it is not necessary that the additional cutout be identical in shape with the cutout 30 formed in the substrate 11.

As described so far, according to the present embodiment 5, the choke coil can be mounted at a lower height. As a consequence, the inverter can be miniaturized without reducing the inductance value of the choke coil.

### Embodiment 6

FIG 11 is a side elevation, partly in cross section, of the inverter 1 according to embodiment 6 of the present invention. In FIG. 11, those portions which are identical with their respective counterparts of FIG. 9 are indicated by the same reference numerals as in FIG. 9. A cutout 30 and a hole 31 are formed by blanking, cutting off, or other work in portions of the substrate 11 and the metal enclosure 10 which are opposite to the surface at one axial end (lower end) of the rod-like core 15. The outside diameter of the hole 31 is set larger than the diameter of the rod-like core 15 The rod-like core 15 is so disposed that its one axial end (lower end) is fitted in the hole 31 formed in the substrate 11.

In the present embodiment 6, a nonmetallic pedestal 32 is disposed in the hole 31 formed in the metal enclosure 10. The surface at one axial end (lower end surface) of the rod-like core 15 is in contact with the pedestal 32 This makes it possible to place the rod-like core 15 in position.

The height of the pedestal 32 may be set at will. The pedestal 32 may extend the hole 31 formed in the substrate 11. Where the rod-like core 15 and the bottom surface of the hole 31 in the metal enclosure 10 are close to each other, the effects of eddy currents can suppressed by forming an additional cutout in the bottom surface of the hole 31 of the metal enclosure 10. In this configuration, if the additional cutout is located opposite to the rod-like core 15 and so shaped that it blocks eddy currents as shown in FIGS. 3A-3D, then it is not necessary that the additional cutout be identical in shape with the cutout 30 formed in the substrate 11.

As described so far, according the present embodiment 6, the rod-like core 15 can be placed in position easily and enhanced productivity is provided. Decreases in the inductance value due to eddy currents can be suppressed by increasing the distance between the rod-like core 15 and the metal enclosure 10.

### Embodiment 7

FIG. 12 is a side elevation partly in cross section, of the inverter 1 according to embodiment 7 of the present invention. Those portions of FIG. 12 which are identical with their respective counterparts of FIG. 9 are indicated by the same reference numerals as in FIG. 9. A hole 31 is formed by blanking, cutting off, or other work in portions of the substrate 11 and metal enclosure 10 which are located opposite to the surface at one axial end (lower end) of the rod-like core 15 The outside diameter of the hole 31 is set larger than the diameter of the rod-like core 15. The rod-like core 15 is so disposed that its one axial end (lower end) is fitted in the hole 31 formed in the substrate 11.

A pedestal 33 made of a magnetic material and having a concave cross section is disposed in the hole 31 formed in the substrate 11 and metal enclosure 10 so as to cover the bottom and side surfaces of the hole 31 Any cutout such as the aforementioned cutout 30 is not formed, The surface of the rod-like core 15 at its one axial end (lower end surface) is in contact with the pedestal 33 of magnetic material. This facilitates placing the rod-like rod 15 in position.

As described so far, according to the present embodiment 7, the pedestal 33 of magnetic material suppresses the magnetic field produced by the choke coil 2 from penetrating the metal enclosure 10 and metal base 18. Decreases in the inductance value due to eddy currents can be suppressed. The use of the pedestal 33 of magnetic material makes it easy to place the rod-like core 15 in position.

### Embodiment 8

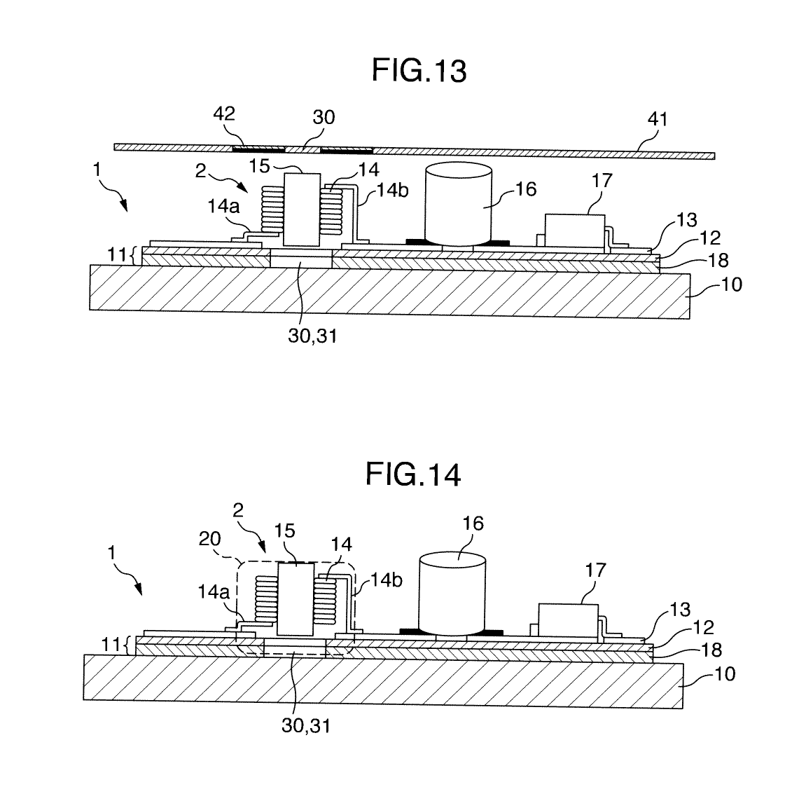

FIG. 13 is a side elevation, partly in cross section, of the inverter 1 according to embodiment 8 of the present invention. Those portions of FIG. 13 which are identical with their respective counterparts of FIGS. 1, 4, and 7 are indicated by the same reference numerals as in FIGS. 1, 4, and 7.

In the present embodiment 8 a printed w icing board 41 that is a second substrate is disposed on the opposite side of the choke coil 2 from the substrate 11, i.e., on a side of the other axial end (upper end) of the rod-like core 15.

An IC for controlling the semiconductor device 17 and other parts, a power-supply circuit for driving the IC, an operational amplifier for controlling other components, and other elements are mounted on the printed wiring board 41 in an unillustrated manner. A cutout 30 is formed in a portion of printed wiring 42 on the printed wiring board 41 which is located opposite to the surface at the other axial end (upper end surface) of the rod-like core 15. This cutout 30 is so shaped that it blocks eddy currents as shown in any one of FIGS. 3A-3D and 6A-6C.

The cutout 30 and a hole 31 are formed in portions of the substrate 11 which are located opposite to the surface at one axial end (lower end) of the rod-like core 15 by blanking, cutting off or other work. The outside diameter of the hole 31 is set larger than the diameter of the rod-like core 15. The rod-like core 15 is so disposed that the surface at one axial end (lower end surface) is just above the hole 31 formed in the substrate 11 and near the height of the surface of the substrate string 13.

The structure constructed as described so far suppresses the magnetic field set up by the choke coil 2 from inducing eddy currents in the printed wiring board 41 as well as in the substrate 11. Decreases in the inductance of the choke coil 2 are suppressed. Also malfunction of electronic parts mounted on the printed wiring board 41 can be suppressed.

Alternatively, a hole may be formed in the surface of the printed wiring board 41 which is opposite to the other axial end (upper end) of the rod-like core 15, an upper end portion of the core 15 may be fitted into the hole in the printed wiring board 41, and a cutout 30 may be formed in peripheral printed wiring 42. Owing to this structure, an inverter having a lower height can be offered.

The printed wring board 41 is an FR4 (flame retardant type 4) multilayer printed wiring board. The board 41 may also be a ceramic multilayer printed wiring board. Even if the substrate 11 is a multilayer substrate, decreases in the inductance value of the choke coil 2 due to eddy currents can be suppressed in the same way as the foregoing by forming the cutout 30 and hole 31.

As described so far, according to the present embodiment 8, in the configuration where the choke coil 2 is mounted on the first substrate 11 at one axial end (lower end) of the rod-like core 15 and the second substrate (printed wiring board) 41 is disposed at the other axial end (upper end), generation of eddy currents in both substrates 11 and 41 is suppressed. The inductance of the choke coil 2 can be suppressed from decreasing.

### Embodiment 9

FIG. 14 is a side elevation, partly in cross section, of the inverter 1 according to embodiment 9 of the present invention. Those portions of FIG. 14 which are identical with their respective counterparts of FIGS. 1 and 4 are indicated by the same reference numerals as in FIGS. 1 and 4A cutout 30 and a hole 31 are formed in portions of a substrate 11 which are located opposite to the surface of the rod-like core 15 at one axial end (lower end) by blanking, cutting off, or other work. The outside diameter of the hole 31 is set larger than the diameter of the rod-like core 15. This core 15 is so disposed that its surface at one axial end (lower end surface) lies just above the hole 31 formed in the substrate 11 and close to the surface of the substrate wiring 13 (i.e., at a height close to the height of the substrate wiring 13).

The cutout 30 and hole 31 may also be formed in the metal enclosure 10, in the same a as in the configuration shown in FIG. 9.

In the present embodiment 9, after placing the rod-like core 15 in position in the cutout 30 and hole 31 formed in the substrate 11 or metal enclosure 10, adhesive 20 is applied to the rod-like core 15 and to the coil element 14 including the coil terminals 14a and 14b Alternatively, adhesive 20 may be applied to the coil element 14 including the coil terminals 14a and 14b and also to the substrate 11 and/or the metal enclosure 10. Thus, these components are bonded together. Because of the configuration described so far, an adhesive bonding step for placing the rod-like core 15 in position and another adhesive bonding step for suppressing vibrations of the coil element 14 can be carried out concurrently.

Furthermore, by selecting an adhesive having a large thermal conductivity as the adhesive 20, heat generated by the coil element 14 and rod-like core 15 can be effectively dissipated away to the substrate 11 and metal enclosure 10. In addition, where a material including a magnetic substance is selected as the adhesive 20, the flux leakage decreases, and decreases in the inductance value of the choke coil 2 can be more suppressed.

In the configurations of FIGS. 1, 4, 7, and 9-13, an adhesive bonding step of placing the rod-like core 15 in position and another adhesive bonding step of suppressing vibrations of the coil element 14 can be carried out simultaneously, as well as in the configuration of FIG. 14.

It should be further understood by those skilled in the art that although the foregoing description has been made on embodiments of the invention, the invention is not limited thereto and various changes and modifications may be made without departing from the spirit of the invention and the scope of the appended claims.

1. A power converter comprising:
a first substrate on which electronic parts are mounted;
a metal enclosure securely holding the substrate; and
a choke coil of an open magnetic path structure, the choke coil having a cylindrical c disposed perpendicularly to the substrate, the choke coil being electrically connected with the substrate via current input-output portions of a coil element;
wherein at least one cutout is formed in a surface of the first substrate which is located opposite to one axial end of the cylindrical core of the choke coil.

2. The power converter of claim 1, wherein said cutout has a hole portion.

3. The power converter of claim 2, wherein said hole portion intersects an end portion of said first substrate.

4. The power converter of claim 1, wherein at least one cutout is formed in a surface of said metal enclosure which is opposite to one axial end of the cylindrical core of said choke coil.

5. The power converter of claim 2, wherein said hole portion has an outside diameter set greater than an outside diameter of said choke coil.

6. The power converter of claim 2, wherein a nonmetallic pedestal is disposed in said hole portion.

7. The power converter of claim 2, wherein a pedestal made of a magnetic material is disposed in said hole portion.

8. The power converter of claim 1, further comprising a second substrate disposed opposite to a surface of said first substrate which is on the opposite side of said metal enclosure,
wherein at least one cutout is formed in a surface of the second substrate which is opposite to the other axial end of the cylindrical core of said choke coil.

9. The power converter of claim 1, wherein said cylindrical core and said coil element of said choke coil are adhesively bonded together, and wherein said choke coil and said first substrate and/or said metal enclosure are adhesively bonded together.
